(19) United States
(12) Patent Application Publication
(10) Pub. No.: US 2006/0194025 A1
(43) Pub. Date: Aug. 31, 2006

(54) Multi-layer dimpled heat shields

(76) Inventor: Ernest Oxenknecht, Downers Grove, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/068,326

(22) Filed: Feb. 28, 2005

(51) Int. Cl. B32B 1/00

(52) U.S. Cl. 428/174

(57) ABSTRACT

A multi-layer heat shield with complementary contours or dimples formed in adjacent layers. The dimples provide contact between layers that dampen vibrations. The dimples may be formed concurrently in all layers with a stamping die. The dimples increase the heat shield's damping.

### FIELD OF INVENTION

The present invention relates to protective heat shields for vehicular engine parts, such as engine exhaust manifolds that transmit substantial heat and vibration during engine operation. More specifically, the invention relates to fabrication of protective heat shields and novel application of structures that increase the damping of such heat shields.

### BACKGROUND

The exhaust manifolds of internal combustion engines in today's modern vehicles can reach under-the-hood temperatures exceeding 1600 degrees Fahrenheit. Such high temperatures create significant risks of damage to electronic components sharing under-the-hood space with the manifolds. Thus, protection has been provided for such components via use of heat shields designed to at least partially cover up and insulate exhaust manifolds and other heat generating components. In some cases, the shields have been effective to reduce measured temperature levels to within a range of 300 degrees Fahrenheit.

A typical multilayer heat shield positioned adjacent a component such as an exhaust manifold uses spaced metal layers with air gaps between the layers. These heat shields transmit heat along the layer directly adjacent the component while the next adjacent layer is insulated from this heat by the air gap. However, since the metal layers are free to vibrate, they typically resonate and transmit undesired noise.

Other multilayer heat shields use metal layers with insulation interposed between the layers. Unlike heat shields without insulation, the insulation dampens the vibrations of the metal layers at locations of contact. Typically, a normal, inward force is provided between the metal layers to ensure increased contact between the insulation and metal layers in order to dampen the vibrations in the metal layers. However, these heat shields may vibrate in areas without contact between the layers, thereby transmitting noise.

The outer metal layer is typically formed of aluminized sheet steel. To increase the effectiveness of the shield and reduce the space required for the shield, the metal layers may be contoured to closely resemble the shape of the outer surface of the exhaust manifold. To provide the desired contour in sheet steel, the resulting outer metal layer of a heat shield typically includes a number of wrinkles. These wrinkles reduce the aesthetic appearance of the heat shields, thin any anti-corrosion coating that may be applied, provide thinned brittle stress regions for future areas of cracking and other failures, and decrease the natural frequency of the heat shield in the region of the wrinkle which may excite frequencies in other regions of higher natural frequency in the heat shield and increase noise transmission.

An example of the above described prior art heat shield for an exhaust manifold is illustrated in FIG. 1. The prior art heat shield 10 includes a contoured outer surface 12 that is formed from a layer of sheet steel to closely contour the outer surface of an exhaust manifold as can be seen. Outer surface 12 includes wrinkles 14 resulting from the forming operation that produces the prior art heat shield 10. These wrinkles reduce the aesthetic appeal of the engine compartment of an automobile.

### SUMMARY

The present invention provides an improved multilayer insulated heat shield for engine components, such as exhaust manifolds of internal combustion engines. In accordance with one aspect of the invention, metal layers of the heat shield are dimpled, or otherwise contoured to provide increased surface area for heat transfer, reduce wrinkling, improve aesthetics, strengthen the heat shield from bending, and/or to provide a heat shield with a narrower range of natural frequencies in differing regions.

In one embodiment, a heat shield includes at least three layers. An outer layer has outer dimples formed therein. An inner layer has inner dimples formed therein. At least a portion of the inner dimples and the outer dimples are nested. An insulating layer is positioned between the inner layer and the outer layer.

In another embodiment, a heat shield for an under-the-hood vehicular engine component includes an outer metal layer, an inner metal layer selectively positioned directly proximal to a shielded component, and an insulation layer partially between the metal layers. The outer metal layer and the inner metal layer are dimpled. The insulation layer is interposed at least partially between the metal layers and the dimples of the metal layers interact to dampen vibrations of the heat shield.

A method of manufacturing a heat shield in accordance with the present invention is also disclosed. The inventive method includes forming outer dimples in an outer layer, and forming inner dimples in an inner layer. At least a portion of the outer dimples and at least a portion of the inner dimples are nested when the outer layer is positioned adjacent the inner layer. The method further includes positioning the outer layer adjacent the inner layer.

### BRIEF DESCRIPTION OF THE DRAWINGS

FIG. 1 is a side elevation view of a prior art heat shield.

FIG. 2 is a side elevation view of a portion of an engine, illustrating an embodiment of a heat shield in accordance with the present invention.

FIG. 3 is a sectional view of the heat shield of FIG. 2, taken along fragmented line 3-3.

FIG. 4 is a side elevation view of an embodiment of a heat shield in accordance with the present invention.

FIG. 5 is an enlarged sectional view of a portion of the heat shield of FIG. 4, with background portions removed for clarity.

FIG. 6 is a fragmentary view a further embodiment of a heat shield surface.

### DETAILED DESCRIPTION

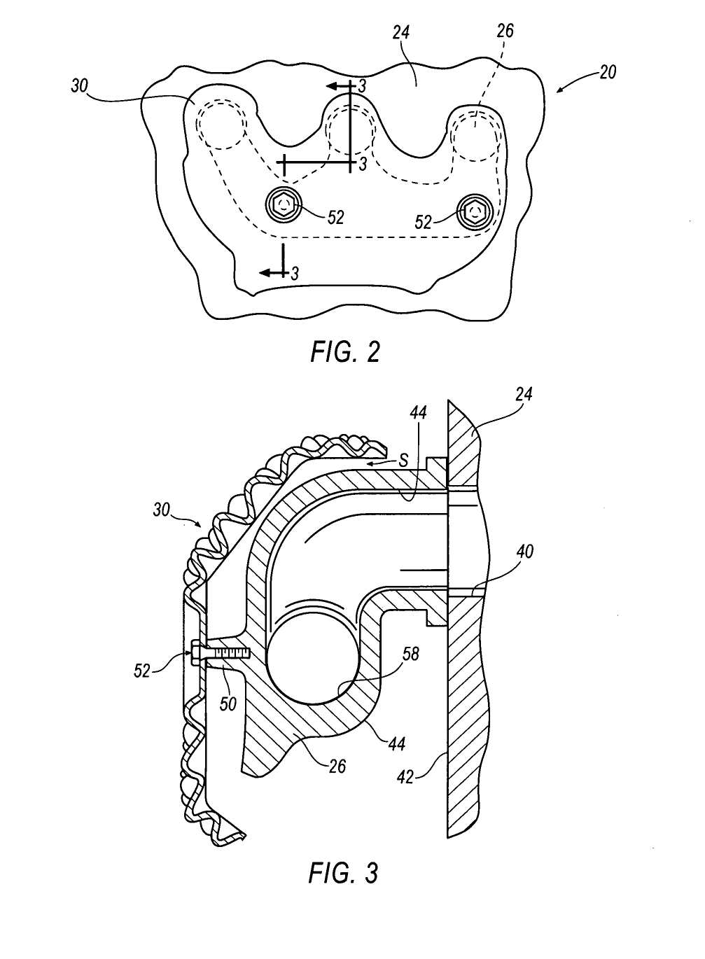

FIGS. 2 and 3 illustrate a portion of an engine 20. Engine 20 includes a cylinder head 24, an exhaust manifold 26, and a heat shield 30. The heat shield 30 is adapted to encase or closely surround at least portions of the exhaust manifold 26. The exhaust manifold 26 is bolted via bolts (not shown) to a plurality of engine exhaust ports 40 on the flank or side 42, of the cylinder head 24.

The exhaust manifold 26 includes cooperating ports 44 in fluid communication with exhaust ports 40. The exhaust manifold 26 also includes mounting bosses 50 for attachment of the heat shield 30 to the exhaust manifold 26 via bolts 52. The engine exhaust ports 40 operate to collectively receive exhaust gases from individual combustion chambers (not shown) of the engine 20, and to funnel those exhaust gases into a common exhaust pipe portion 58 of the exhaust manifold 26.

As best seen in FIGS. 3, 4 and 5, the heat shield 30 includes a contoured body 60. The contoured body 60 dampens the structure of heat shield 30, thereby permitting heat shield 30 to attenuate vibrations, as described in greater detail below.

FIG. 5 illustrates heat shield 30 to include an inner metal layer 70, and an outer metal layer 72, with an insulation layer 74 interposed therebetween. Inner metal layer 70 includes a first inner surface 80 and a second inner surface 82 that faces insulation layer 74, with inner dimples 84 formed therein. Outer metal layer 72 includes a first outer surface 90 that faces insulation layer 74 and a second outer surface 92, with outer dimples 94 formed therein. Insulation layer 74 includes an inner surface 100 that faces inner metal layer 70 and an outer surface 102 that faces outer metal layer 72, with insulation dimples 104 formed therein.

As best seen in FIG. 5, the inner metal layer 70, the outer metal layer 72, and the insulation layer 74 are positioned such that the inner dimples 84, the outer dimples 94, and the insulation dimples 104 are at least partially nested. Nested refers to the condition where a dimples resides within another dimple. Specifically, one inner dimple 84 and one outer dimple 94 are nested when a portion of the inner dimple 84 intersects a plane (illustrated as plane P-P in FIG. 5) generally defined by first outer surface 90. Testing of a representative heat shield 30 having nested dimples demonstrated a 27% increase in damping factor over an undimpled heat shield. Alternatively, insulation layer 74 may be thicker such that at least a portion of inner dimples 84 and outer dimples 94 may be aligned and not nested to provide some degree of vibration dampening.

During operation of heat shield 30, inner metal layer 70 is generally at a greater temperature than outer metal layer 72. Therefore, inner metal layer 70 will expand more than outer metal layer 72. The differential expansion of layers will create a small normal force inwardly interacting between the inner metal layer 70 and the outer metal layer 72. In addition to the normal force that may exist for both the prior art heat shield 10 and the heat shield 30, inner dimples 84 and outer dimples 94 interact with the insulation dimples 104 of the insulation layer 74 to dampen vibrations within the inner metal layer 70 and the outer metal layer 72. Dimples 84, 94 increase the area of contact between layers 70, 72, and 74, thereby increasing the dampening of heat shield 30.

Preferably, outer dimples 94 are randomly scattered and not aligned within outer metal layer 72 in such a manner that would create an undesirable bending plane within the outer metal layer 72 and heat shield 30. While the curvature of an exhaust manifold heat shield in accordance with the teachings herein may be less susceptible to bending than a larger, less curved heat shield, an exhaust manifold heat shield would benefit from a scattering of dimples 84, 94. Alternatively, a repetitive pattern 114 of dimples 84′, 94′, 104′, as illustrated in FIG. 6, may be formed in layers 70′, 72′, 74′ to attenuate vibrations while discouraging an undesirable bending plane.

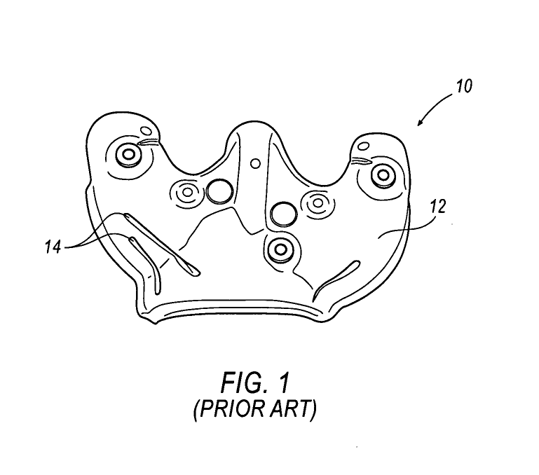

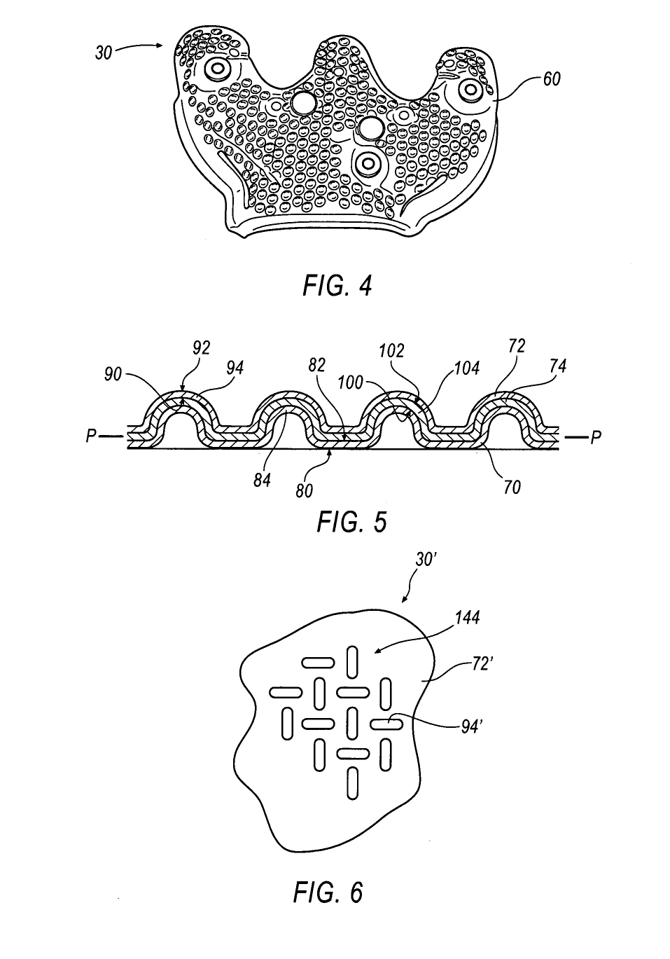

As best seen in FIGS. 1 and 4, the formation of outer dimples 94 act to stretch the skin of outer metal layer 72 such that surface wrinkles 14 of the prior art heat shield 10 are less pronounced. In this manner, outer dimples 94 improve the aesthetic appeal of heat shield 30 while decreasing the undesirable effects of wrinkles 14, such as thinning any anti-corrosion coating that may be applied and creating thinned brittle stress regions for future areas of cracking and other failures.

The outer metal layer 72 may be preferably formed of cold rolled steel, aluminized steel, aluminum, and even stainless steel for more exotic vehicles where cost is less of a factor. If cold rolled steel is utilized, the exterior of the shield may be coated with a corrosion-resistant material to enhance longevity of the shield.

The inner metal layer 70 is the portion of the heat shield 30 in closest contact with the exhaust manifold 26. To the extent that the temperatures of the manifold can reach 1600 degrees Fahrenheit, the material of the inner metal layer 70 should be able to withstand significant heat. In some applications the inner metal layer 70 may be relatively shiny, formed of high-temperature alloys, and adapted to reflect heat back to the shielded component. In others, the inner metal layer 70 can be of cheaper materials including aluminum-clad steel. Those skilled in the art will appreciate that choice of materials may be critical for avoiding degradation associated with elevated temperatures and for handling considerable vibrations in particular applications.

Although described with three layers, the heat shield 30 could be effectively manufactured with additional layers, or with insulation layer 74 applied in selective regions of heat shield 30. The inner metal layer 70 would provide the requisite stiffness and support in such cases, but may need to be relatively thicker in some applications. Additionally, while outer dimples 94 and inner dimples 84 are illustrated as extending away from exhaust manifold 26, the all or a portion of the dimples 84, 94 may extend toward exhaust manifold 26.

The material choices for the thermally insulating and vibration and noise dampening insulation layer 74 are fairly broad. Such choices may include non-metallic fibers such as aramid fibers, or ceramic fiber paper. Depending on anticipated temperature ranges, even non-fiber compositions may be employed, such as densified vermiculite powders, for example.

One method of manufacturing of the heat shield 30 can be described as follows. The inner metal layer 70 and the outer metal layer 72 with the insulation layer 74 interposed between are positioned within a progressive die (not shown). The layers 70, 72, 74 are stamped and formed in the progressive die to the shapes depicted, including the dimples 84, 94, 104. The layers 70, 72, 74 may be trimmed either before, after, or during stamping. The progressive die includes male and female forming tools that are pressed together with layers 70, 72, 74 positioned therebetween. The male and female forming tools have complementary surfaces cut therein to form dimples 84, 94, 104.

As the male and female forming tools are pressed together, layers 70, 72, 74 are formed into the general shape depicted in FIGS. 2 and 3 without significant dimple formation. In the last few millimeters of die travel, the dimples 84, 94, 104 are formed within the layers 70, 72, 74. The outer edges of layers 70, 72 are then attached, such as by crimping, and may be crimped before removal from the progressive die.

As best seen in FIGS. 3 and 5, when heat shield 30 is formed with a contoured body 60, and outer edges of layers 70, 72 are attached, such as by crimping, the dimples 84, 94, 104 are held in contact by the normal force that exists between the layers due to the curvature of heat shield 30. This normal force in a contoured body 60 increases contact between dimples 84, 94, 104, although a planar heat shield would benefit from the interaction between dimples of adjacent layers.

Alternatively, the inner metal layer 70 and the outer metal layer 72 may be formed separately in the general shape depicted in FIGS. 2 and 3 without dimples 84, 94, then layered with the insulation layer 74, and then stamped in a die to form the dimples 84, 94, 104.

Preferably, the outer metal layer 72 will be relatively and slightly oversized compared to inner metal layer 70, so that edges (not shown) of the outer metal layer 72 may be folded over respective mated edges of the inner metal layer 70, effectively encapsulating the insulation layer 74 between the layers 70, 72. Dimples 84, 94 may be generally hemispherical or have a generally conical portion.

It is to be understood that the above description is intended to be illustrative and not limiting. Many embodiments will be apparent to those of skill in the art upon reading the above description. Therefore, the scope of the invention should be determined, not with reference to the above description, but instead with reference to the appended claims, along with the full scope of equivalents to which such claims are entitled.

What is claimed is:

1. A multiple layer heat shield comprising:
an outer layer having outer dimples formed therein;
an inner layer having inner dimples formed therein, wherein at least a portion of said inner dimples and at least a portion of said outer dimples are nested together such that at least a portion of said inner dimples are disposed within said outer dimples; and
at least one insulating layer interposed between said inner layer and said outer layer.

2. The heat shield of claim 1, wherein all of said inner dimples and said outer dimples are nested.

3. The heat shield of claim 1, wherein said outer dimples are defined at least in part by a hemispherical section.

4. The heat shield of claim 1, wherein said outer dimples have a circular cross-section when viewed normal to a surface of said outer layer.

5. The heat shield of claim 1, wherein said outer dimples have an elongated cross-section when viewed normal to a surface of said outer layer.

6. The heat shield of claim 1, wherein said inner layer and said outer layer define a contoured body having a predetermined shape, wherein said curved heat shield body increases interaction between said inner dimples and said outer dimples.

7. The heat shield of claim 1, wherein said inner and outer dimples are randomly scattered on said inner and outer layers.

8. The heat shield of claim 1, wherein each of said inner dimples are nested within at least one said outer dimples.

9. A heat shield for an under-the-hood vehicular engine component comprising:
an outer metal layer having dimples;
an inner metal layer having dimples and selectively positioned directly proximal to a shielded component; and
an insulation layer interposed at least partially between said metal layers wherein at least a portion of said dimples of said metal layers interact to dampen vibrations of said heat shield.

10. The heat shield of claim 9, wherein at least a portion of said dimples of said metal layers are nested.

11. The heat shield of claim 9, wherein said dimples are defined at least in part by a hemispherical section.

12. The heat shield of claim 9, wherein said dimples have a circular cross-section when viewed normal to a surface of said outer layer.

13. The heat shield of claim 9, wherein said dimples have an elongated cross-section when viewed normal to a surface of said outer layer.

14. The heat shield of claim 9, wherein said inner layer and said outer layer define a contoured body, wherein said curved heat shield body increases interaction between said inner dimples and said outer dimples.

15. The heat shield of claim 9, wherein said inner dimples are defined by a first inner surface and a second inner surface, said outer dimples are defined by a first outer surface and a second outer surface, said second inner surface faces said insulation layer, and wherein said first outer surface faces said insulation layer.

16. A method of manufacturing a heat shield comprising the steps of:
forming outer dimples in an outer layer;
forming inner dimples in an inner layer such that at least a portion of said outer dimples and at least a portion of said inner dimples are nested when said outer layer is positioned adjacent said inner layer; and
positioning said outer layer adjacent said inner layer.

17. The method of claim 16, further comprising the step of interposing an insulation layer between said outer layer and said inner layer, wherein said insulation layer resides between at least a portion of said outer dimples and at least a portion of said inner dimples.

18. The method of claim 17, wherein said steps of forming outer dimples and forming inner dimples are performed concurrently within a stamping die.

19. The method of claim 17, wherein the step of positioning is performed before the steps of forming.

20. The method of claim 18, wherein the step of positioning is performed before the steps of forming.

21. The method of claim 18, wherein said steps of forming outer dimples and forming inner dimples are performed concurrently within a stamping die.

22. The method of claim 16, further comprising the step of forming said inner layer and said outer layer into a contoured body having a curved surface.
